(19) United States
(12) Patent Application Publication
(10) Pub. No.: US 2019/0133875 A1
(43) Pub. Date: May 9, 2019

(54) LEG MASSAGE DEVICE

(71) Applicant: BODYFRIEND Co., Ltd., Seoul (KR)

(72) Inventors: Sung Chan CHOI, Seoul (KR); Cheulkyu JIN, Busan (KR); Myeong Jin YOU, Incheon (KR); Giwon UM, Gwangmyeong-si (KR)

(21) Appl. No.: 16/047,861

(22) Filed: Jul. 27, 2018

(30) Foreign Application Priority Data
Nov. 3, 2017 (KR) 10-2017-0145779

(51) Int. Cl. A61H 15/00; A61H 7/00

(52) U.S. Cl. CPC A61H 15/0078; A61H 7/004; A61H 23/0254; A61H 2205/10; A61H 2201/1669; A61H 2205/12

(57) ABSTRACT

A leg massage device includes a calf massage module and an up/down movement module to move the calf massage module up and down. The calf massage module includes a unit massage module including a massage module plate, a moving roller installed on the massage module plate to move up and down along a guide surface, and a calf massage roller mounted on the massage module plate to massage the user's calf. The up/down movement module includes a driving link unit connected to the massage module plate to push up or pull down the massage module plate and a driving power source configured to provide power to the driving link unit.

### CROSS-REFERENCE TO RELATED APPLICATION

This application claims priority to and the benefit of Korean Patent Application No. 10-2017-0145779, filed on Nov. 3, 2017, the disclosure of which is incorporated herein by reference in its entirety.

### BACKGROUND

### 1. Field of the Invention

The disclosure relates to a leg massage device, and more particularly, to a leg massage device capable of providing a uniform massage throughout a user's calf muscles.

### 2. Discussion of Related Art

In general, a leg massage device is used to massage a lateral side of a user's calf, or additionally a sole of the user.

For this purpose, the leg massage device includes an air cell having an airbag to massage a lateral side of the calf by providing air pressure to the lateral side of the calf, and a sole massage roller provided at a lower portion of the leg massage device for a massage of the sole.

As the related art, there is provided a leg massage device (see Korean Utility Model Registration No. 20-0407310) having massage functions for a lateral side of the calf and the sole as described above. However, this leg massage device has no massage function for a rear side of the calf. In addition, it is necessary to develop a leg massage device capable of providing a massage along the contour of the calf while overcoming the limitation of the static massage provided through the airbag.

### SUMMARY OF THE INVENTION

According to an aspect of the disclosure, there is provided a leg massage device capable of providing the uniform massage along the contour of the calf throughout the calf muscle.

Objects of the disclosure are not limited to the above-mentioned object, and other objects will be clearly comprehended by those skilled in the art from the following description.

In order to achieve the above object, a leg massage device according to one embodiment of the disclosure includes: a calf massage module including a massage module plate, a moving roller installed on the massage module plate and moving up and down along a guide surface, and a calf massage roller installed on the massage module plate to massage a user's calf; and an up/down movement module including a driving link unit connected to the massage module plate to push up or pull down the massage module plate, and a driving power source configured to provide power to the driving link unit.

The driving link unit may include a driving link having one side connected to the massage module plate and a driving cam connected to an opposite side of the driving link to push up or pull down the driving link while rotating, and the driving power source may include a first driving motor configured to rotate the driving cam.

The first driving motor may provide rotational power to the driving cam through a first gearbox.

The guide surface may include a guide slope having an inclined surface which gradually ascends from an upper side to a lower side thereof.

The calf massage module may further include a housing unit including a front housing, a rear housing and a lower housing, and the guide surface may be formed on the rear housing.

A unit massage module may include a fixed housing in which the moving roller is installed; a pair of fixing brackets installed in the fixed housing and configured to support a shaft of the calf massage roller; and a pair of compression springs located at outer portions of the pair of fixing brackets, respectively, in which one end of the compression spring is in contact with a mounting seat formed in the fixed housing and an opposite end of the compression spring is in contact with a mounting protrusion formed on the massage module plate.

The guide surface may include a guide slope having an inclined surface which gradually ascends from an upper side to a lower side thereof, and the fixed housing may move forward or rearward as the moving roller moves up and down along the guide slope, and as a result, pressure applied by the mounting seat of the fixed housing to the compression springs changes, so that the compression springs are compressed or expanded, and at the same time, the calf massage roller moves back and forth.

The leg massage device may further include a guide module configured to guide the calf massage module, and the guide module may include: a guide rail configured to guide an up/down movement of the massage module plate; a guide rib installed rearward of the massage module plate, moving up and down along the guide rail to move the massage module plate up and down, and configured to surround the guide rail; and a guide bracket configured to block the massage module plate at a front of the massage module plate to prevent the massage module plate from departing in a forward direction.

The guide rib may have a sectional shape that surrounds the guide rail.

The leg massage device may further include a sole massage module and the sole massage module may include a sole massage roller; and a second driving motor configured to supply power to the sole massage module.

The second driving motor may supply the power to the sole massage roller through a second gearbox, and a protrusion may be formed on the sole massage roller.

The leg massage device may further include a first air cell located at the lateral side of the user's calf to provide a compression force to the calf using air pressure and a second air cell located at the lateral side of a user's foot portion to provide a compression force to the foot portion using air pressure.

The leg massage device may further include: a housing unit including a front housing, a rear housing, and a lower housing; and a moving wheel mounted on a lower portion of an installation frame connected to the rear housing.

The leg massage device may further include a housing unit including a front housing, a rear housing, and a lower housing, and a moving wheel mounted on the lower housing.

The leg massage device may further include: a housing unit including a front housing, a rear housing, and a lower housing; and a reinforcing frame having an “L” shape and configured to come into contact with an interior of the rear housing and an interior of the lower housing. The reinforcing frame may be a hollow frame.

The leg massage device may further include a housing unit including a front housing, a rear housing and a lower housing, in which an accommodation space may be formed in the front housing to accommodate legs of the user, and in the calf massage roller, protrusion rods may be formed in a longitudinal direction thereof.

### BRIEF DESCRIPTION OF THE DRAWINGS

The above and other objects, features and advantages of the disclosure will become more apparent to those of ordinary skill in the art by describing in detail exemplary embodiments thereof with reference to the accompanying drawings, in which:

FIG. 1 is a perspective view of a leg massage device according to an embodiment of the disclosure;

FIG. 2 is a side view of the leg massage device according to an embodiment of the disclosure;

FIG. 3 is an exploded perspective view of the leg massage device according to an embodiment of the disclosure;

FIG. 4 is a view showing a calf massage module, an up/down movement module, a guide module and a sole massage module installed in a rear housing and a lower housing of the leg massage device according to an embodiment of the disclosure;

FIG. 5A is an exploded perspective view of a calf massage module shown in FIG. 3;

FIG. 5B is a front perspective view of the calf massage module shown in FIG. 3;

FIG. 5C is a rear perspective view of the calf massage module shown in FIG. 3;

FIG. 5D is a perspective view of a unit massage module included in the calf massage module shown in FIG. 3;

FIG. 5E is a sectional view of the calf massage module;

FIG. 6 is an exploded perspective view of an up/down movement module of the leg massage device according to an embodiment of the disclosure;

FIG. 7 is an exploded perspective view of a guide module included in the leg massage device according to an embodiment of the disclosure;

FIG. 8 is an exploded perspective view of a sole massage module of the leg massage device according to an embodiment of the disclosure;

FIG. 9 is a view showing the calf massage module included in the leg massage device according to an embodiment of the disclosure when the calf massage module is located at an upper position;

FIG. 10 is a sectional view taken along line A-A′ of FIG. 9;

FIG. 11 is a view showing the calf massage module included in the leg massage device according to an embodiment of the disclosure when the calf massage module is located at a lower position; and

FIG. 12 is a sectional view taken along line B-B′ of FIG. 11.

### DETAILED DESCRIPTION OF EXEMPLARY EMBODIMENTS

Exemplary embodiments of the disclosure will be described in detail below with reference to the accompanying drawings. While the disclosure is shown and described in connection with exemplary embodiments thereof, it will be apparent to those skilled in the art that various modifications can be made without departing from the spirit and scope of the disclosure. Terms used herein are for the purpose of explaining the embodiments, and are not intended to limit the disclosure.

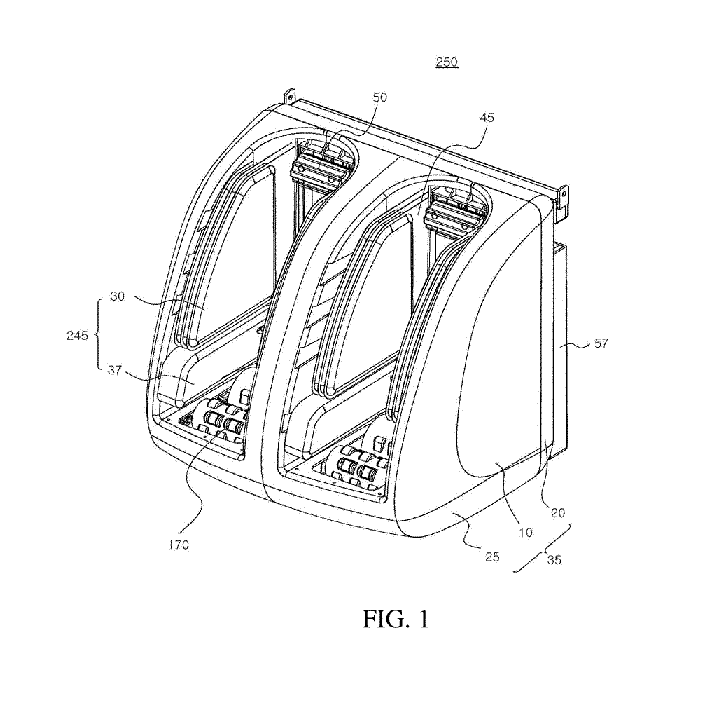

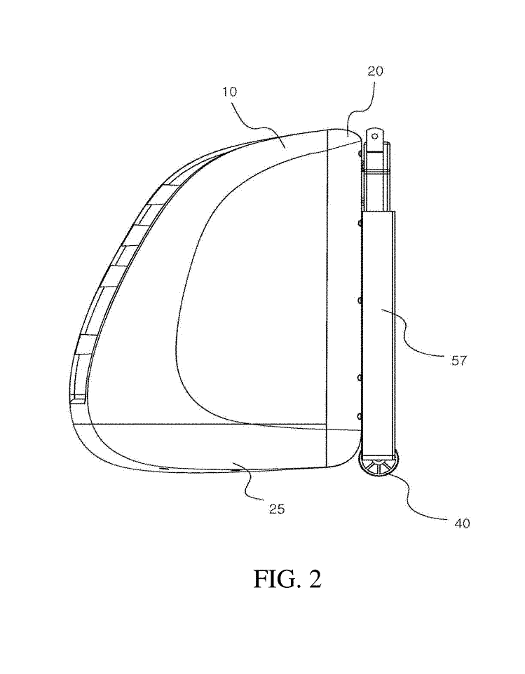

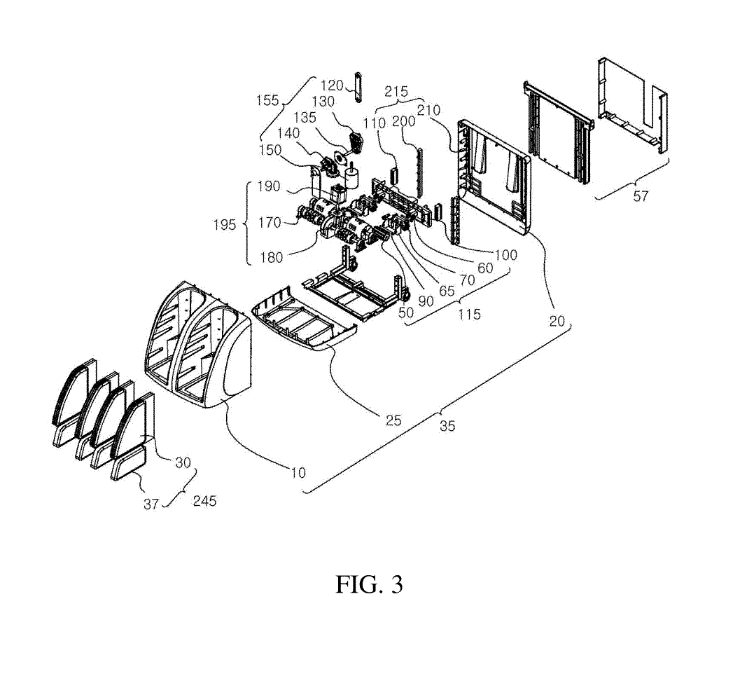

FIG. 1 is a perspective view of a leg massage device according to an embodiment of the disclosure, FIG. 2 is a side view of the leg massage device according to an embodiment of the disclosure, and FIG. 3 is an exploded perspective view of the leg massage device according to an embodiment of the disclosure.

A leg massage device 250 may include a housing unit 35, a calf massage module 115, an up/down movement module 155, a guide module 215, a sole massage module 195, and an air cell unit 245.

The housing unit 35 serves as a body that defines an entire external shape of the leg massage device 250 according to an embodiment of the disclosure and accommodates various components to be described below. The housing unit 35 may include a front housing 10, a rear housing 20, and a lower housing 25. The front housing 10 is located at a front side of the leg massage device 250 and has a pair of accommodation spaces 45 into which a user's legs can be inserted. The user can receive a massage after placing his or her legs in the accommodation spaces 45.

The rear housing 20 is located at a rear side of the leg massage device 250 and a separate installation frame 57 may be installed on an outer surface of the rear housing 20. A moving wheel 40 of the leg massage device 250 may be connected to the separate installation frame 57. Besides the above-described installation position, the moving wheel 40 may be installed at a lower portion of the leg massage device 250, that is, at the lower housing 25. The lower housing 25 constitutes a lower portion of the leg massage device 250 and the moving wheel 40 can be installed at the lower housing 250, if necessary.

The calf massage module 115 is used to massage a rear side of the user's calf. In a conventional leg massage device, only a lateral side of the calf is massaged by using an air cell that provides air pressure to the lateral side of the calf. According to the disclosure, the rear side of the calf may be massaged as well as the lateral side of the calf, so that a uniform massage may be performed throughout the calf muscle along the contour of the calf. To this end, the calf massage module 115 may include a massage module plate 100 and a unit massage module 95.

The up/down movement module 155 is used to move the calf massage module 115 up and down and is connected to the massage module plate 100 to push up or pull down the massage module plate 100.

The guide module 215 is used to guide the calf massage module 115 when the calf massage module 115 is moved up and down by the up/down movement module 155.

The sole massage module 195 is used to massage the sole of the user. The sole massage module 195 may be installed in the lower housing 25 through the lower housing 25 and may include a sole massage roller 179 for massaging the sole of the user.

The air cell unit 245 is a member for massaging the lateral side of the calf and the lateral side of a foot portion and may include a plurality of air cells that massage the lateral side of the calf and the lateral side of the foot portion.

Hereinafter, the calf massage module 115, the up/down movement module 155, the guide module 215, and the sole massage module 195, which are installed in the rear housing 20 and the lower housing 25, will be sequentially described in order to explain the operation of the disclosure.

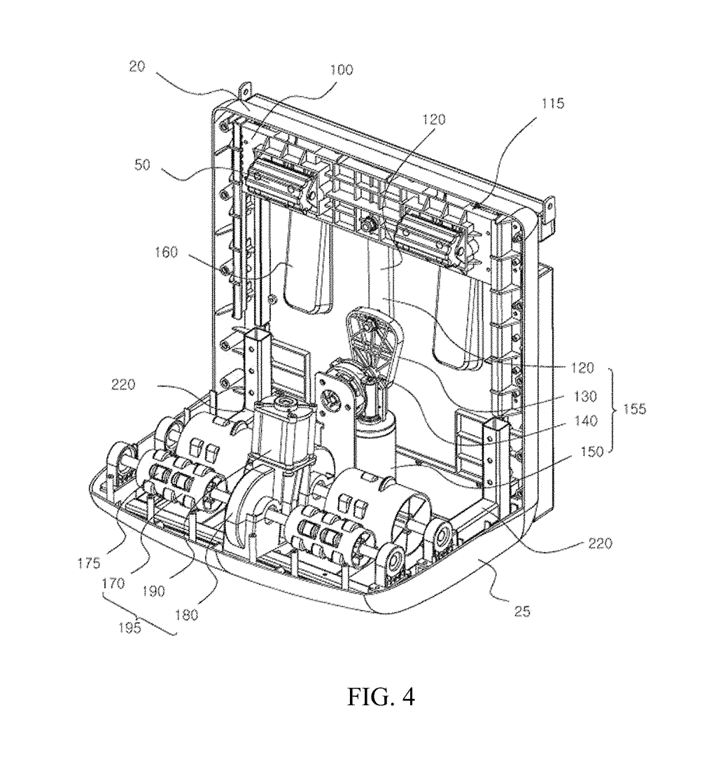

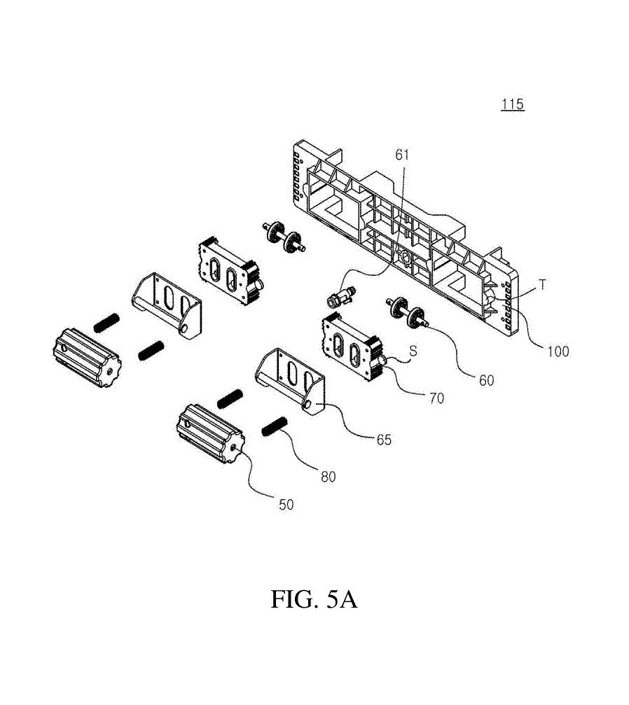

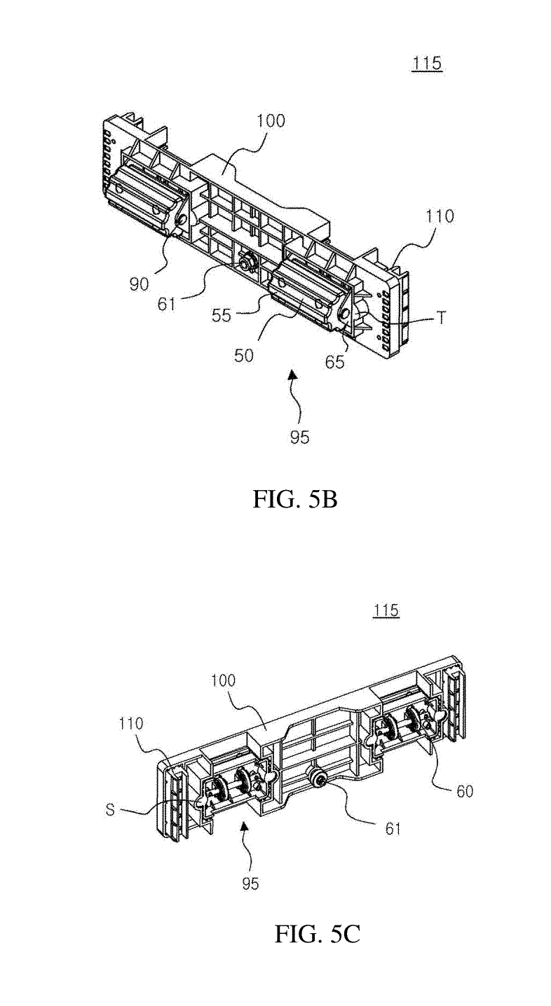

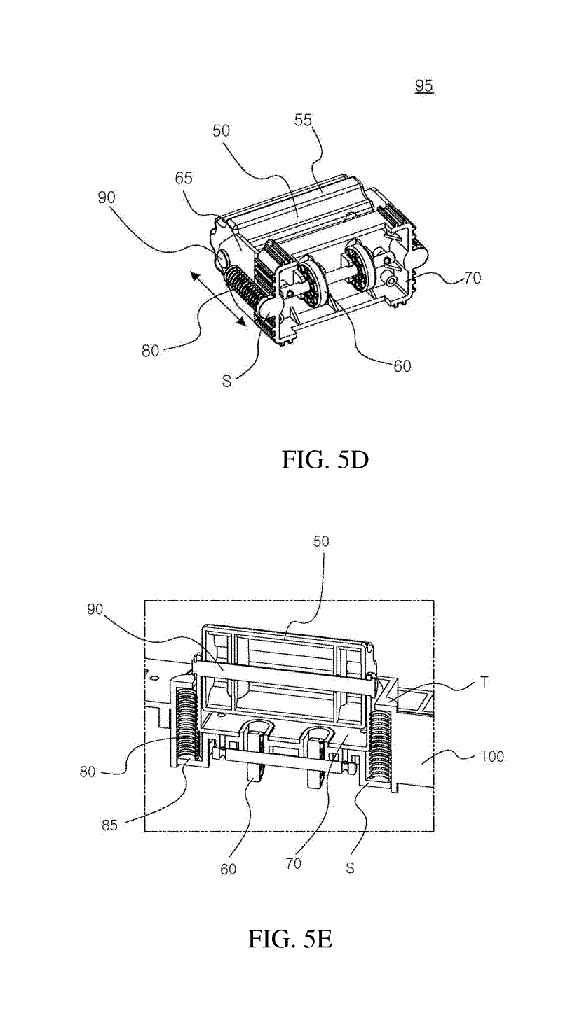

FIG. 4 is a view showing the calf massage module, the up/down movement module, the guide module and the sole massage module installed in the rear housing and the lower housing of the leg massage device according to an embodiment of the disclosure, FIG. 5A is an exploded perspective view of the calf massage module shown in FIG. 3, FIG. 5B is a front perspective view of the calf massage module shown in FIG. 3, FIG. 5C is a rear perspective view of the calf massage module shown in FIG. 3, FIG. 5D is a perspective view of the unit massage module included in the calf massage module shown in FIG. 3, and FIG. 5E is a sectional view of the calf massage module.

The calf massage module 115 is used to massage the rear side of the user's calf. The calf massage module 115 may include the massage module plate 100 and the unit massage module 95 and may be coupled to the rear housing 20 by a fastening screw 61.

The massage module plate 100 may be configured to form an entire external shape of the calf massage module 115, and the unit massage module 95 to be described below may be installed on the massage module plate 100.

The unit massage module 95 is used to directly massage the calf and may include a moving roller 60 moving up and down along a guide surface formed on the rear housing 20 and a calf massage roller 50 integrally formed with the moving roller 60 to massage the rear side of the user's calf. The calf massage roller 50 may have a cylindrical shape and protrusions may be formed on a surface thereof, or alternatively, protrusion rods 55 may be formed in a longitudinal direction thereof to maximize the massage effect.

More specifically, the unit massage module 95 includes a fixed housing 70, which is fixed to the massage module plate 100, and the moving roller 60, which moves up and down along the guide surface, may be installed at a lower portion of the fixed housing 70. Two moving rollers 60 may be provided, but the disclosure is not limited to this number of moving rollers 60. Further, a pair of fixing brackets 65 for supporting a shaft 90 of the calf massage roller 50 may be installed in the fixed housing 70.

In addition, as can be understood from FIG. 5E, the unit massage module 95 may include a pair of compression springs 80, which are disposed at outer portions of the fixing brackets 65, respectively, and one end of the compression spring 80 may be positioned in contact with a mounting seat S formed in the fixed housing 70 and the other end of the compression spring 180 may be positioned in contact with a mounting protrusion T formed on the massage module plate 100. Thus, upper and lower portions of the compression spring 80 may be blocked by the mounting protrusion T of the massage module plate 100 and the mounting seat S of the fixed housing 70 and a lateral side circumference of the compression spring 80 may be surrounded by the massage module plate 100, the fixed housing 70, and the fixing bracket 65. That is, the compression spring 80 may be accommodated in a compression space 85 defined by the above components.

A pair of unit massage modules 95 may be installed on both sides of the massage module plate 100, however, there is no limitation on the installation position and number of unit massage modules 95.

Meanwhile, the guide surface, which is a movement path of the moving roller 60 of the unit massage module 95, may be a guide slope 160 having an inclined surface that gradually ascends from an upper side toward the ground, that is, gradually ascends in the downward direction (or gradually protrudes forward in the downward direction). Such a configuration of the guide surface is adapted for the shape of the calf having a thickness that becomes narrower in the downward direction, so that the unit massage module 95 can more effectively massage the rear side of the calf.

Additionally, as described above, the compression spring 80 of the unit massage module 95 can be accommodated in the compression space 85 and compressed and expanded within the compression space 85. Thus, the calf massage roller 50 may move back and forth along the contour of the rear side of the calf so that the massage can be performed along the contour of the calf.

That is, if there is no external force applied to the calf massage roller 50 due to a shape of a certain point in the rear side of the calf, the compression spring 80 may not be compressed and the unit massage module 95 may not move back and forth. However, as the unit massage module 95 moves up and down, the shape of the rear side of the calf in contact with the unit massage module 95 is changed, so that an external force is applied to the calf massage roller 50. In this case, the compression spring 80 compresses and expands and the calf massage roller 50 may also move back and forth. This will be described below in detail.

Meanwhile, referring to FIG. 4, the leg massage device 250 may include a reinforcing frame 220. The reinforcing frame 220 is a member for ensuring the rigidity of the leg massage device 250. For this purpose, the reinforcing frame 220 has an “L” shape such that the reinforcing frame 220 can be installed through the interior of the rear housing 20 and the interior of the lower housing while coming into contact with the interior of the rear housing 20 and the interior of the lower housing. In addition, the reinforcing frame 220 may be a hollow frame. In this case, the reinforcing frame may have a light weight and a high torsional strength.

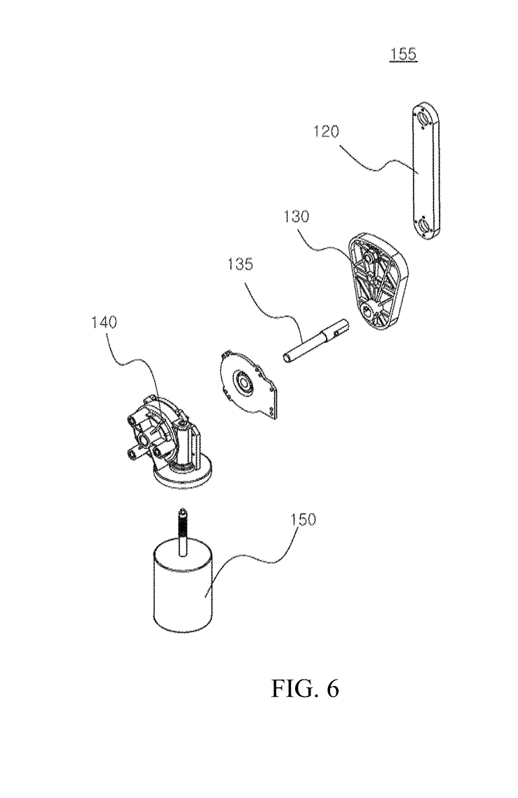

FIG. 6 is an exploded perspective view of the up/down movement module of the leg massage device according to an embodiment of the disclosure;

Referring to FIGS. 4 and 6, the up-and-down movement module 155 is used to move the calf massage module 115 up and down, and may include driving link units 120 and 130 connected to the massage module plate 100 to push up or pull down the massage module plate 100 and driving power sources 140 and 150 that provide power to the driving link units 120 and 130.

In detail, the driving link units 120 and 130 may include a driving link 120 and a driving cam 130, in which one side of the driving link 120 is connected to the massage module plate 100 and the other side thereof is connected to the driving cam 130, and the driving cam 130 is rotatably connected to the other side of the driving link 120 to push or pull the driving link 120. In addition, the driving power sources 140 and 150 may include a first driving motor 150 that rotates the driving cam 130 by providing rotational power to the driving cam 130. The first driving motor 150 may provide the rotational power to the driving cam 130 through a first gearbox 140 and the driving cam 130 may be connected to the first gearbox 140 through a connection shaft 135.

That is, the rotational power of the first driving motor 150 is transmitted to the driving cam 130 through the first gearbox 140 so that the driving cam 130, which receives the rotational power, rotates. In addition, as the driving cam 130 rotates, the driving link 120 connected to the driving cam 130 at the other side moves up and down. As a result, the massage module plate 100 connected to the one side of the driving link 120 may be pulled down or pushed up so that the massage module plate 100 can move up and down.

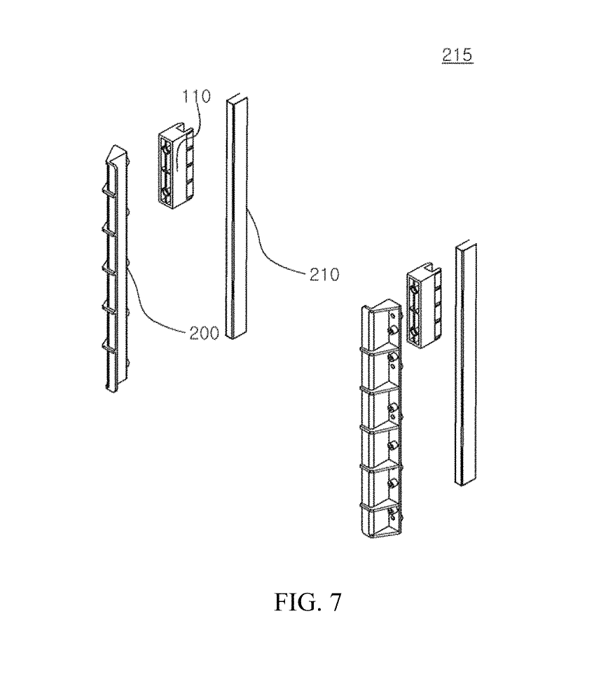

FIG. 7 is an exploded perspective view of the guide module included in the leg massage device according to an embodiment of the disclosure.

Referring to FIGS. 4 and 7, the guide module 215 is used to guide the calf massage module 115 when the calf massage module 115 is moved up and down by the up/down movement module 155 and includes a guide rail 210, a guide rib 110, and a guide bracket 200.

The guide rail 210 may be formed along a vertical direction of the rear housing 20, and is a member for guiding the up/down movement of the massage module plate 100. A pair of guide rails 210 may be provided, but the disclosure is not limited thereto.

The guide rib 110 is installed rearward of the massage module plate 100 and moves up and down along the guide rail 210 to move the massage module plate 100 up and down. That is, according to the disclosure, the massage module plate 100 moves along the guide rail 210 through the guide rib 110 without directly coming into contact with the guide rail 210.

Meanwhile, the guide rib 110 may have a sectional shape that surrounds the guide rail 210. For example, the guide rib 110 may have a C-shaped cross section that surrounds the guide rail 210. However, the above sectional shape is for illustrative purposes only and the guide rib 110 may have a U-shaped cross-section as well as the C-shaped cross-section. The guide rib 210 may have various sectional shapes as long as they surround the guide rail 210. As a result, the massage module plate 100 may move up and down along the guide rail 210 without being moved in the left and right direction.

The guide bracket 200 may be positioned at both sides of the massage module plate 100, in which one side of the guide bracket 200 may be connected to the rear housing 20 and the other side of the guide bracket 200 blocks a predetermined portion of the massage module plate 100 at the front of the massage module plate 100, thereby preventing the massage module plate 100 from departing in a forward direction.

That is, the guide rib 110 prevents the massage module plate 100 from being moved in the left and right direction, and the guide bracket 200 prevents the massage module plate 100 from departing in a forward direction, thereby ensuring a stable up/down movement of the massage module plate 100.

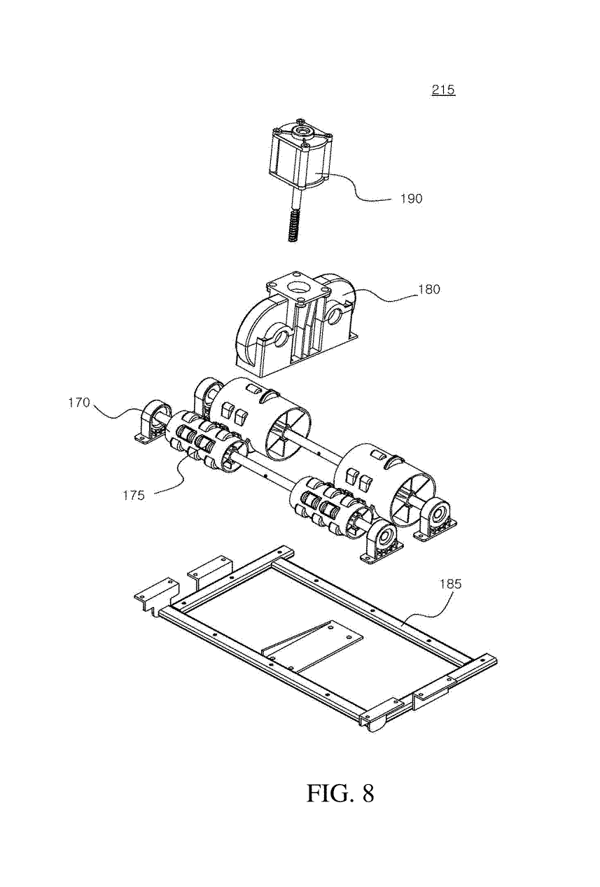

FIG. 8 is an exploded perspective view of the sole massage module of the leg massage device according to an embodiment of the disclosure;

Referring to FIGS. 4 and 8, the sole massage module 195 is used to massage the user's sole. The sole massage module 195 may be installed inside the lower housing 25 through an installation frame 185, and include a sole massage roller 170 that massages the user's sole. Protrusions 175 may be formed on an outer surface of the sole massage roller 170 to maximize the massage effect. In addition, the sole massage module 195 may include a second driving motor 190 that provides power to the sole massage roller 170 through a second gearbox 180 to rotate the sole massage roller 170.

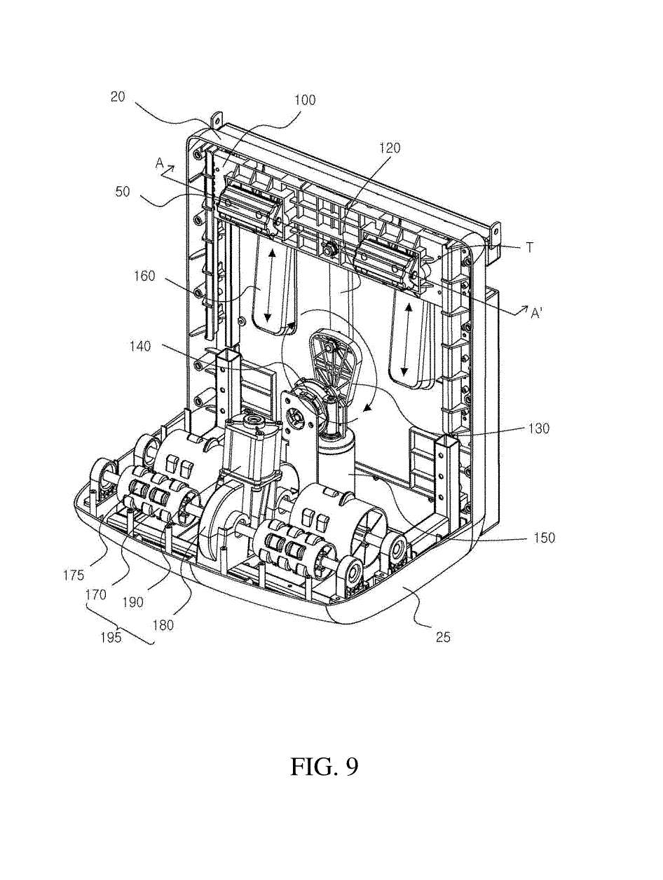

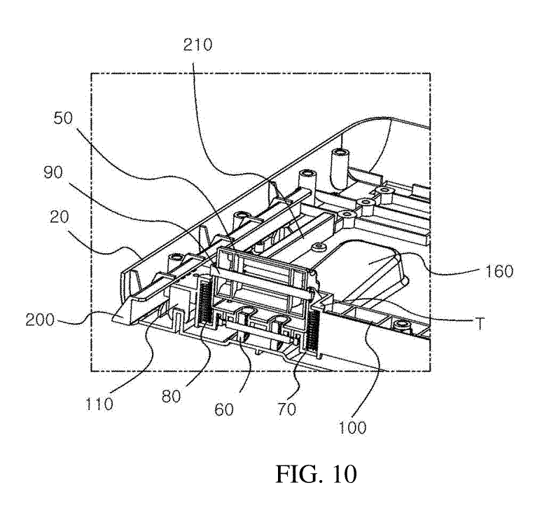

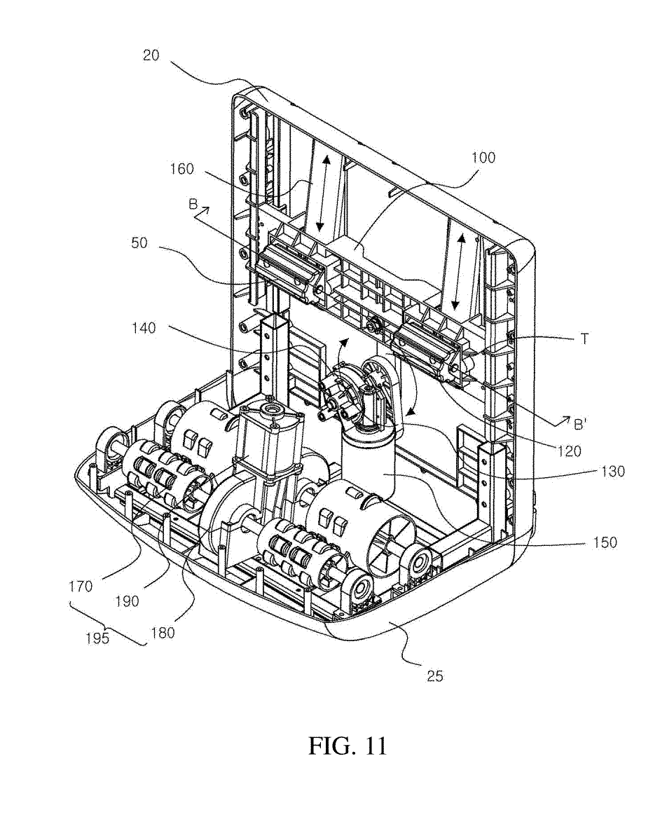

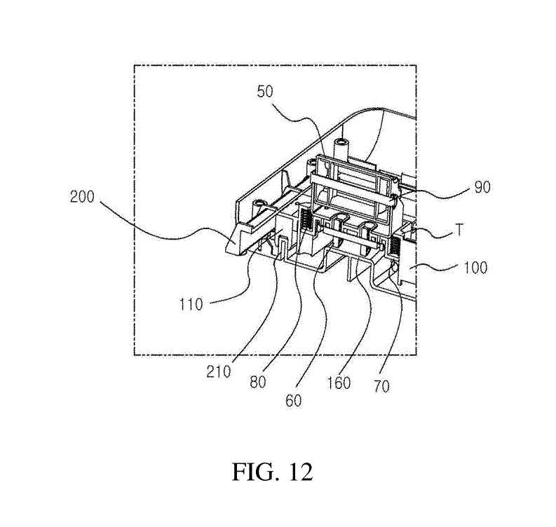

FIG. 9 is a view showing the calf massage module included in the leg massage device according to an embodiment of the disclosure when the calf massage module is located at an upper position, FIG. 10 is a sectional view taken along line A-A′ of FIG. 9, FIG. 11 is a view showing the calf massage module included in the leg massage device according to an embodiment of the disclosure when the calf massage module is located at a lower position, and FIG. 12 is a sectional view taken along line B-B′ of FIG. 11.

Hereinafter, the process of massaging the rear side of the calf while the calf massage module 115 moves up and down will be described in more detail with reference to FIGS. 9 to 12.

Referring to FIGS. 9 and 10, the calf massage module 115 is located at the uppermost position of the rear housing 20, and the driving link 120 is not yet pulled by the driving cam 130. In addition, the compression spring 80 of the unit massage module 95 may be positioned in an uncompressed state within the compression space 85 defined by the massage module plate 100, the fixing bracket 65 and the fixed housing 70.

Then, referring to FIGS. 11 and 12, as the first driving motor 150 is operated under the state as shown in FIG. 9, the rotational power is transmitted to the driving cam 130 through the first gearbox 140, so that while the driving cam 130 which receives the rotational power is rotated, the driving link 120 is pulled.

As a result, the calf massage module 115 moves down, and at the same time, the moving roller 60 moves along the guide slope 160. Since the guide slope 160 gradually ascends (or gradually protrudes forward) in the downward direction, the fixed housing 70, which is integrated with the moving roller 60, moves forward, and as a result, the mounting seat S of the fixed housing 70 moves forward while compressing the compression spring 80 against the mounting protrusion T of the massage module plate 100. That is, as the calf massage module 115 moves down, the compression spring 80 of the unit massage module 95 is compressed, and at the same time, the unit massage module 95 protrudes forward so that the calf massage roller 50 presses the rear side of the calf.

In addition, the moving roller 60 moves up and down along the guide slope 160 and the shape of the rear side of the calf is changed, so that the fixed housing 70 of the unit massage module 95 moves forward or rearward. As a result, the pressure applied by the mounting seat S of the fixed housing 70 to the compression spring 80 is changed so that the compression spring 80 is compressed or expanded, and at the same time, the calf massage roller 50 moves back and forth to massage the rear side of the calf along the contour of the calf.

At this time, simultaneously, the air cell unit 245 may be operated to massage the lateral side of the user's leg, and the sole massage module 195 may massage the user's sole. Thus, a uniform massage may be achieved throughout the user's calf muscles.

According to the disclosure, a leg massage device can provide a massage along the contour of a rear side of the calf, so that it is possible to provide a uniform massage throughout the calf muscle while overcoming the limitation of a static massage using air pressure provided through an airbag.

While the embodiments of the disclosure have been described with reference to the accompanying drawings, it will be understood that the above-described embodiments are for illustrative purposes only and are not intended to limit the disclosure.

What is claimed is:

1. A leg massage device comprising:
a calf massage module including a massage module plate, a moving roller installed on the massage module plate and moving up and down along a guide surface, and a calf massage roller installed on the massage module plate to massage a user's calf; and
an up/down movement module including a driving link unit connected to the massage module plate to push up or pull down the massage module plate, and a driving power source configured to provide power to the driving link unit.

2. The leg massage device of claim 1, wherein the driving link unit includes a driving link having one side connected to the massage module plate and a driving cam connected to an opposite side of the driving link to push up or pull down the driving link while rotating, and
the driving power source includes a first driving motor configured to rotate the driving cam.

3. The leg massage device of claim 1, wherein the guide surface includes a guide slope having an inclined surface which gradually ascends from an upper side to a lower side thereof.

4. The leg massage device of claim 1, wherein the calf massage module further includes:
a fixed housing in which the moving roller is installed;
a pair of fixing brackets installed in the fixed housing and configured to support a shaft of the calf massage roller; and
a pair of compression springs located at outer portions of the pair of fixing brackets, respectively, in which one end of the compression spring is in contact with a mounting seat formed in the fixed housing and an opposite end of the compression spring is in contact with a mounting protrusion formed on the massage module plate.

5. The leg massage device of claim 4, wherein the guide surface includes a guide slope having an inclined surface which gradually ascends from an upper side to a lower side thereof, and
the fixed housing moves forward or rearward as the moving roller moves up and down along the guide slope, and as a result, pressure applied by the mounting seat of the fixed housing to the compression springs changes, so that the compression springs are compressed or expanded, and at the same time, the calf massage roller moves back and forth.

6. The leg massage device of claim 1, further comprising a guide module configured to guide the calf massage module,
wherein the guide module comprises:
a guide rail configured to guide an up/down movement of the massage module plate;
a guide rib installed rearward of the massage module plate, moving up and down along the guide rail to move the massage module plate up and down, and configured to surround the guide rail; and
a guide bracket configured to block the massage module plate at a front of the massage module plate to prevent the massage module plate from departing in a forward direction.

7. The leg massage device of claim 1, further comprising:
a housing unit including a front housing, a rear housing and a lower housing; and
a moving wheel mounted on a lower portion of an installation frame connected to the rear housing.

8. The leg massage device of claim 1, further comprising:
a housing unit including a front housing, a rear housing and a lower housing; and
a reinforcing frame having an “L” shape and configured to come into contact with an interior of the rear housing and an interior of the lower housing.

9. The leg massage device of claim 8, wherein the reinforcing frame comprises a hollow frame.

10. The leg massage device of claim 1, wherein, in the calf massage roller, protrusion rods are formed in a longitudinal direction thereof.
